(19) United States
(12) Patent Application Publication
(10) Pub. No.: US 2005/0187828 A1
(43) Pub. Date: Aug. 25, 2005

(54) Referral system for handling information on order entry and sales

(76) Inventors: Hisayuki Ban, Tokyo (JP); Makoto Itou, Toda (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/044,000

(22) Filed: Jan. 28, 2005

(30) Foreign Application Priority Data
Feb. 23, 2004 (JP) 2004-045583

(51) Int. Cl. G06F 17/60

(52) U.S. Cl. 705/25; 705/26

(57) ABSTRACT

A referral system for handling information on order entry and sales includes: means adapted to receive an order; means for extracting providers which can handle the order received; means for making an inquiry to the providers for handling availability; means for selecting a provider based on the inquiry; means for making a reservation at the provider if the provider can handle the order; means for providing at least part of the information obtained with the above-stated means to an orderer; and means for feeding back achievement information and/or various types of service information to the provider. With such arrangement, it is possible to provide the referral system for handling information on order entry and sales which comprises the steps of: referring to a product or a service; acquiring order/inquiry information for the product or the service; making an inquiry to each company which provides a product or a service satisfying the acquired information as to whether the companies can handle sales or service thereof; and feeding back information on a hot-selling product and/or a service to each company according to available history information from each company.

### CLAIMS OF PRIORITY

The present application claims prority from Japanese application serial no. JP2004-045583, filed on Feb. 23, 2004, the content of which is hereby incorporated by reference into this application.

### BACKGROUND OF THE INVENTION

The present invention relates to systems that receive an order for sales or demonstration and transmit the information thereof to a random computer via a network, and more specifically to a system that discriminates the information and provides adequate information to a computer that satisfies the discriminated information.

Conventionally, as a referral system for handling information on order entry and sales which, when receiving an order for sales or demonstration, discriminates the information and provides adequate information to a computer that satisfies the discriminated information, a system, represented by Japanese Patent Laid-open No. 2003-9167, which makes a referral to a product based on changes in natural environment has been known.

The above-stated prior art only describes a product referral by grasping the seasonal consumption trend.

An object of the present invention is to provide a referral system for handling information on order entry and sales which comprises the steps of: making reference to a product or a service; acquiring information on an order/inquiry for the product or the service; making reference to each company which provides a product or a service that satisfies the acquired information as to whether the company can handle the product or the service; and feeding back information on hot-selling products or services to each company based on handling history information of each company.

A second object of the present invention is to provide a referral system for handling information on order entry and sales which is not designed to develop information after receiving information from customers, but is designed to judge target industries based on past achievement data, transmit information on products or services of partner companies after acquiring the latest company information on their websites, etc., and enhance sales opportunities of the partner companies.

A third object of the present invention is to provide a referral system for handling information on order entry and sales which is designed to select partner companies whose schedules are not tight for a quotation request from a customer, acquire an quotation from each of the partner companies, judge adequacy of the quotations at the same time, and select the most adequate partner company for the customer.

### SUMMARY OF THE INVENTION

To achieve the above-described objects, a system of the present invention includes: means adapted to receive an order; means for extracting providers which can handle the order received; means for inquiring availability of the providers; means for selecting a provider based on the results of such inquiries; means for making a reservation at the provider if the provider is available for the order;
means for providing at least part of information obtained by the above-stated means to an orderer; and means for feeding back achievement information or various service information to the provider.

According to the present invention, information on hot-selling products can be provided through the inquiry status, which enables to formulate business plans covering priority of products on which each partner should focus on, revealing loss of business opportunities due to opportunity loss from the information on the number of unsuccessful order entries, and enabling the partner companies to grasp actual status according to evaluations from the associating inquiry source companies, thus enabling to take measures for optimizing the business strategy. In addition, with the above description, the number of partner companies will expand and the number of registered products will increase, which enhances demand in referral information servers, thus enabling to expand business opportunities.

Further, according to the present invention, the types of business can be shifted to the PUSH type from the PULL type. In addition, regarding conditions for giving a PUSH to new customers, it is possible to conduct activities for expanding sales while narrowing down the targets, since product information is delivered after competitive types of business of partner companies is judged.

Furthermore, quotation adequacy has been checked manually; however, with the present invention, quotation adequacy can be systematically checked by introducing an SI server, so that rapid quotation reply can be made to customers.

### BRIEF DESCRIPTION OF DRAWINGS

FIG. 1 is a configuration diagram of a referral system for handling information on order entry and sales according to a preferred embodiment of the present invention;

FIG. 2 is a configuration diagram of a referral information server shown in FIG. 1;

FIG. 3 is a configuration diagram of a partner analysis server;

FIG. 4 is a flow chart showing processing procedures of the referral information server shown in FIG. 2;

FIG. 5 is a flow chart showing processing procedures of the partner analysis server shown in FIG. 2;

FIG. 6 is a layout diagram of a table to be managed by a company information DB shown in FIG. 2;

FIG. 7 is a layout diagram of a table to be managed by an inquiry information DB shown in FIG. 2.

FIG. 8 is a layout diagram of a table to be managed by a registered products DB shown in FIG. 2;

FIG. 9 is a layout diagram of a table to be managed by a partner information DB shown in FIG. 2;

FIG. 10 is a layout diagram of a table to be managed by an inquiry judgment conditions DB shown in FIG. 2;

FIG. 11 is a layout diagram of a table to be managed by an inquiry judgment results DB shown in FIG. 2;

FIG. 12 is a layout diagram of a table to be managed by an external information. DB shown in FIG. 2;

FIG. 13 is a layout diagram of a table to be managed by an inquiry judgment results DB shown in FIG. 2;

FIG. 14 is a layout diagram of a table to be managed by a job achievements DB shown in FIG. 2;

FIG. 15 is an example of result notification to be transmitted according to partners.

FIG. 16 is a configuration diagram of a referral system for handling information on order entry and sales according to another embodiment of the present invention.

FIG. 17 is a configuration diagram of a customer analysis server shown in FIG. 16;

FIG. 18 is a configuration diagram of an SI server shown in FIG. 16

FIG. 19 is a configuration diagram of servers dedicated to partner companies shown in FIG. 16;

FIG. 20 is a flow chart showing processing procedures of the customer analysis server shown in FIG. 17;

FIG. 21 is a flow chart showing processing procedures of the SI server shown in FIG. 18;

FIG. 22 is a layout diagram of a table to be managed by a target partners DB shown in FIG. 17;

FIG. 23 is a layout diagram of a table to be managed by a customer jobs DB shown in FIG. 17;

FIG. 24 is a layout diagram of a table to be managed by an industry classification DB;

FIG. 25 is a layout diagram of a table to be managed by a target industries DB shown in FIG. 17;

FIG. 26 is a layout diagram of a table to be managed by a new customers DB shown in FIG. 17;

FIG. 27 is a layout diagram of a table to be managed by a quotation conditions DB shown in FIG. 18;

FIG. 28 is a layout diagram of a table to be managed by an available partners DB shown in FIG. 18;

FIG. 29 is a layout diagram of a table to be managed by a partner check conditions DB shown in FIG. 18;

FIG. 30 is a layout diagram of a table to be managed by a quotation results DB shown in FIG. 18;

FIG. 31 is a layout diagram of a table to be managed by a registered product prices DB shown in FIG. 18;

FIG. 32 is a layout diagram of a table to be managed by a disclosing jobs DB shown in FIG. 19; and

FIG. 33 is a layout diagram of a table to be managed by a disclosing schedules DB.

### DESCRIPTION OF THE PREFERRED EMBODIMENTS

### First Embodiment

Hereinafter, a first embodiment according to the present invention will be described in detail with reference to the accompanying drawings.

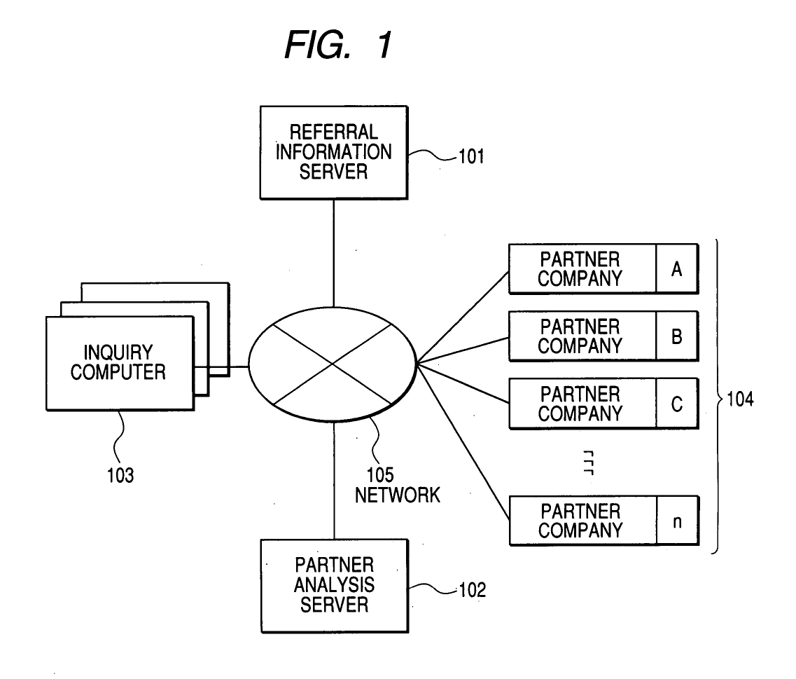

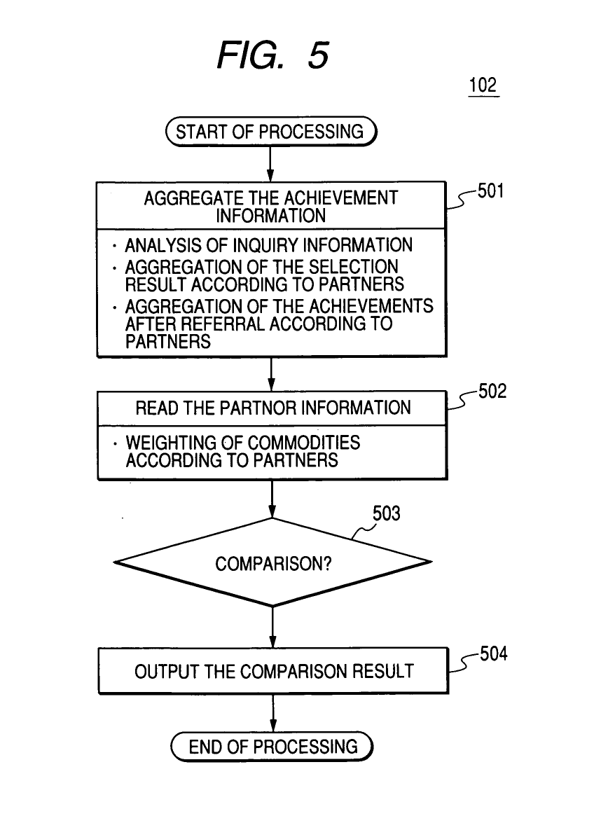

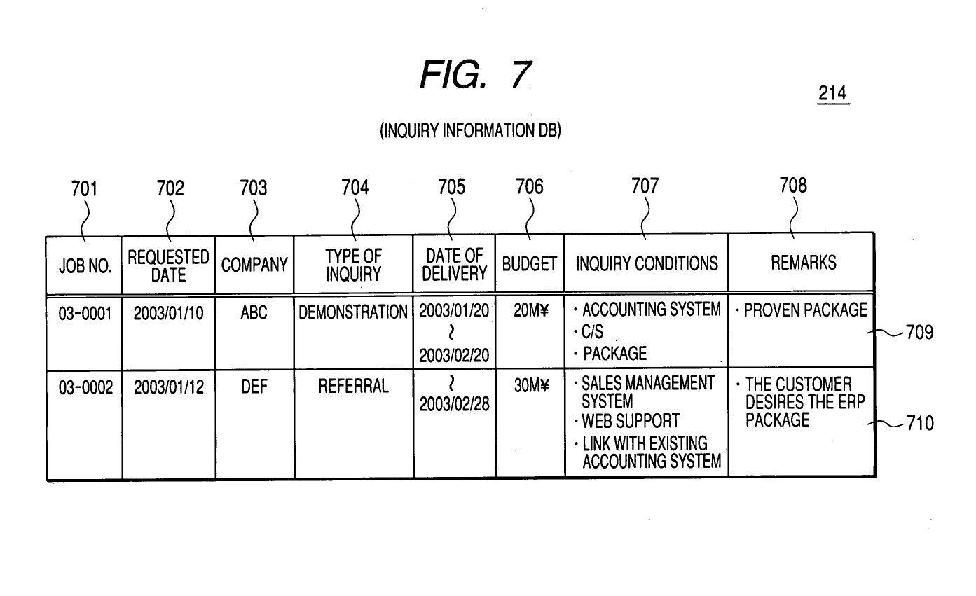

FIG. 1 is a configuration diagram of a referral system for handling information on order entry and sales according to the first embodiment of the present invention. As shown in FIG. 1, this system includes an referral information server 101, a partner analysis server 102, inquiry computers 103 which transmits inquiry information, and partner computers 104 which provides referral information and business information to each partner, and acquires business information for the partners, which are connected via a network 105. FIG. 7 shows details of the inquiry information. FIG. 5 shows details of the referral information and the business information.

The referral information server 101 in the referral system for handling information on order entry and sales shown in FIG. 1 acquires inquiry information from the inquiry computers 103, selects the most adequate product based on the information, judges the inquiry information, selects the most adequate partner, and transmits a reply to the inquiry computers 103 and job handling request to the partner computers 104.

The referral information server 101 and the partner analysis server 102 in the referral system for handling information on order entry and sales shown in FIG. 1 can be operated on a single server.

The configuration diagram of the referral information server 101 will be described later.

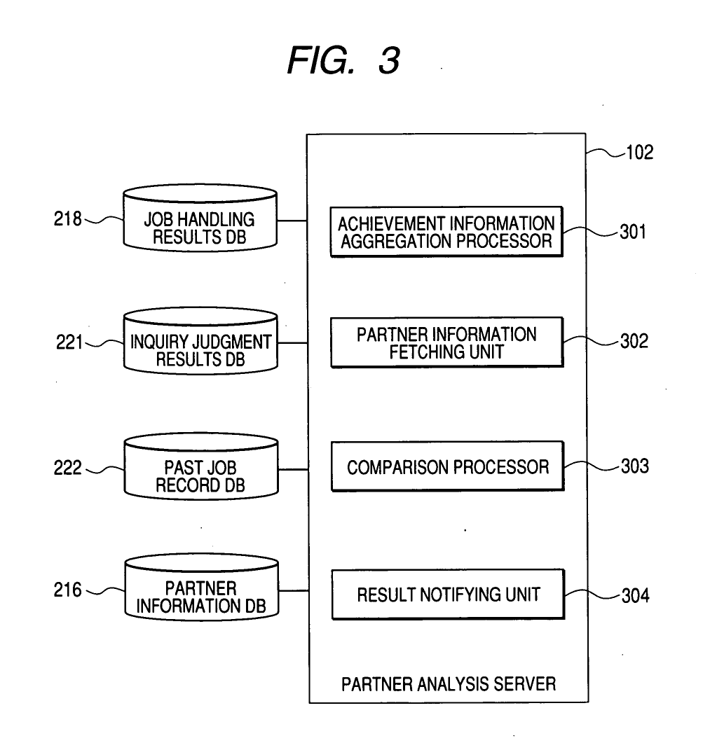

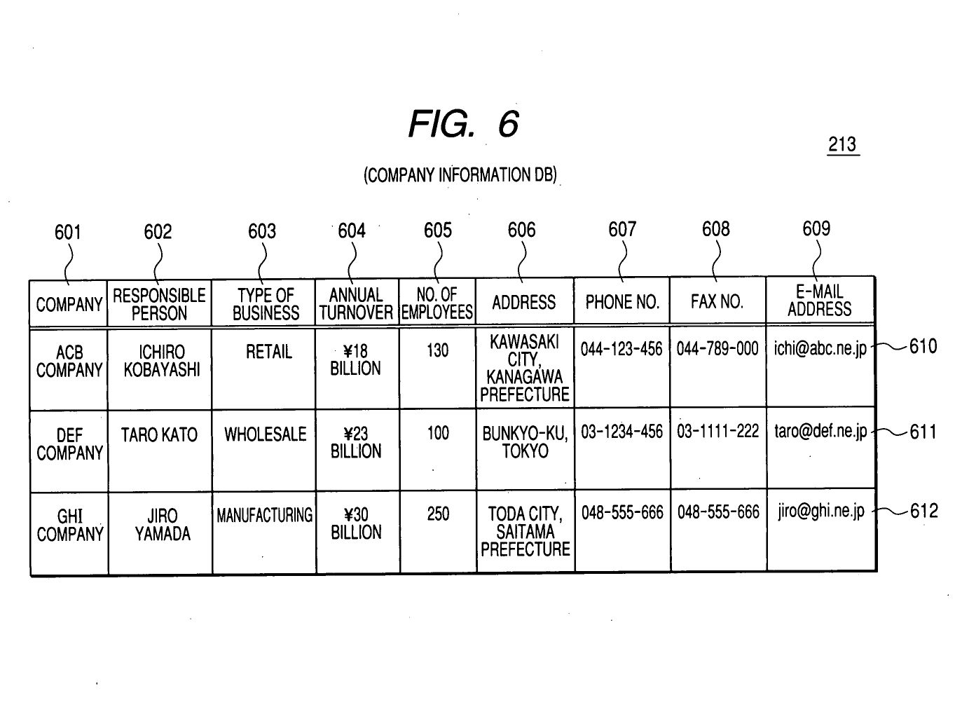

The partner analysis server 102 shown in FIG. 1 analyzes inquiry information received from the inquiry server 103, and achievement information on product selection and partner selection in each inquiry. FIG. 5 shows the analysis procedures, wherein information acquired from the partner computers 104 is compared with the achievement information, and the comparison results are provided to the partner computers 104. FIG. 6 shows the comparison results. The configuration diagram of the partner analysis server 102 will be described later with reference to FIG. 3.

The respective layout diagrams of tables to be used in the referral system for handling information on order entry and sales shown in FIG. 1 are explained shown below. The tables are created in the referral information server 101 and, likewise, the information is stored in the referral information server 101. When information is referred to from the partner analysis server 102, the information is acquired via a network.

FIG. 6 is a layout diagram of a table to be managed by a company information DB 213. The table contains items such as a company 601, responsible person 602, a type of business 603, annual turnover 604, the number of employees 605, and point-of-contact information such as an address 606, a phone number 607, a FAX number 608 and an e-mail address 609. In addition, each of the items stores such line data as represented by reference numerals 610, 611 and 612, for example.

FIG. 7 is a layout diagram of a table to be managed by an inquiry information DB 214. The table contains items such as a job No. 701, a requested date 703, a type of inquiry 704, a date of delivery 705, a budget 706, inquiry conditions 707 and remarks 708. In addition, each of the items stores such line data as represented by reference numerals 709 and 710, for example.

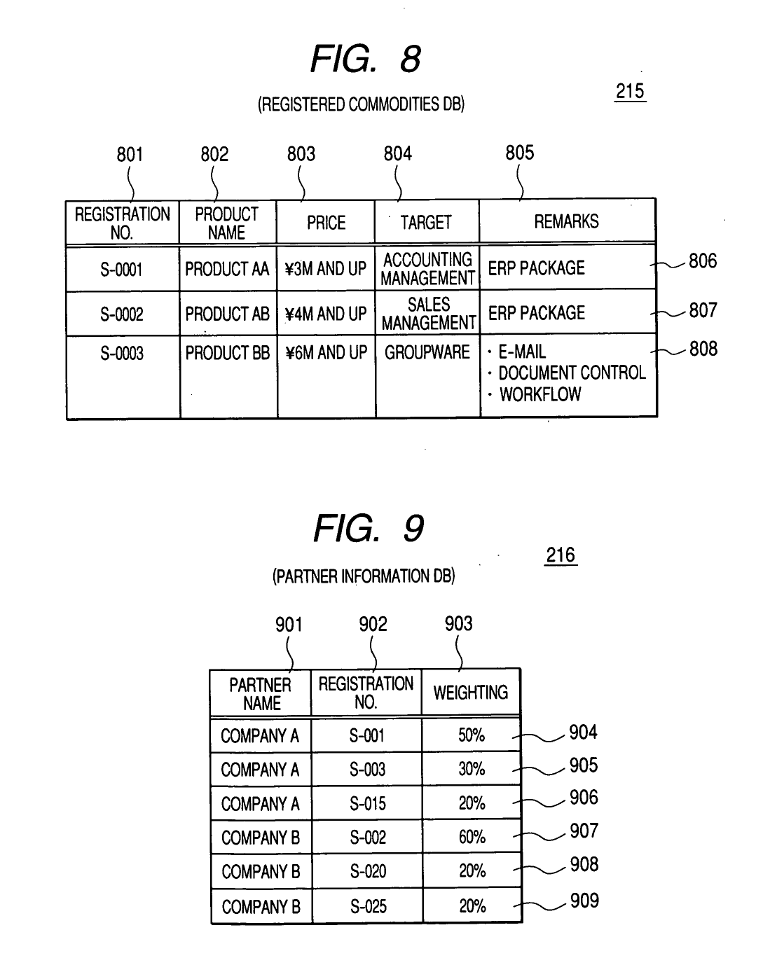

FIG. 8 is a layout diagram of a table to be managed by a registered products DB 215. The table contains items such as a registration No. 801, a product name 802, a price 803, a target 804 and remarks 805. In addition, each of the items stores such line data as represented by reference numerals 806, 807 and 808, for example.

FIG. 9 is a layout diagram of a table to be managed by a partner information DB 216. The table contains items of a partner name 901, a registration No. 902 and weighting 903. In addition, each of the items stores such line data as represented by reference numerals 904, 905 and 906; 907, 908 and 909, for example. The weighting is added up to 100 for one partner company.

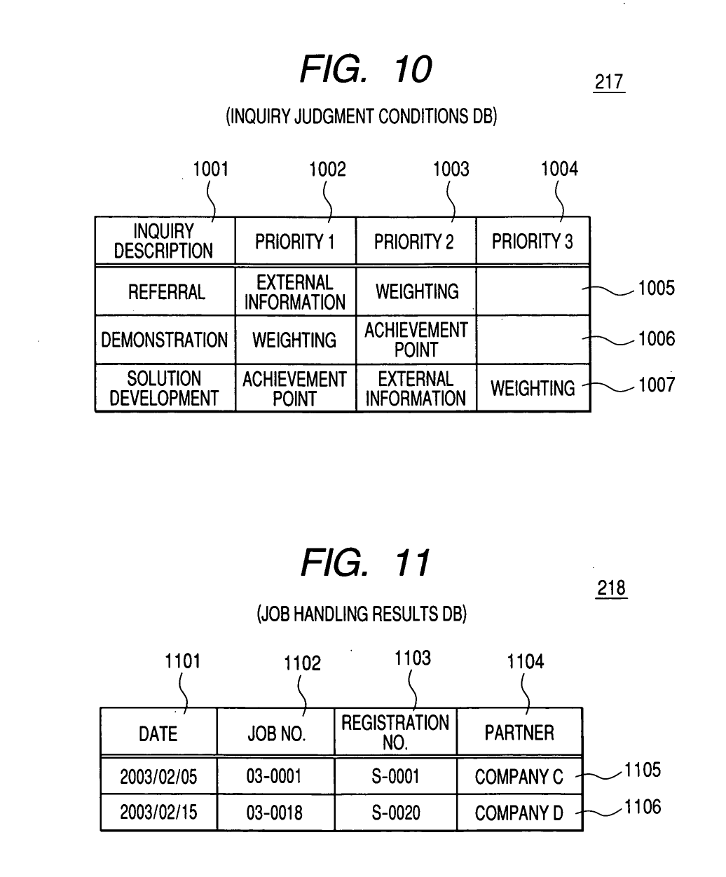

FIG. 10 is a layout diagram of a table to be managed by an inquiry judgment conditions DB 217. The table contains items such as inquiry description 1001, priority 1 (1002), priority 2 (1003) and priority 3 (1004). In addition, each of the items contains such line data as represented by reference numerals 1005, 1006 and 1007, for example.

FIG. 11 is a layout diagram of a table to be managed by a job handling results DB 218. The table contains items of a date 1101, a job No. 1102, a registration No. 1103 and a partner 1104. In addition, each of the items contains such line data as represented by reference numerals 1105 and 1106, for example.

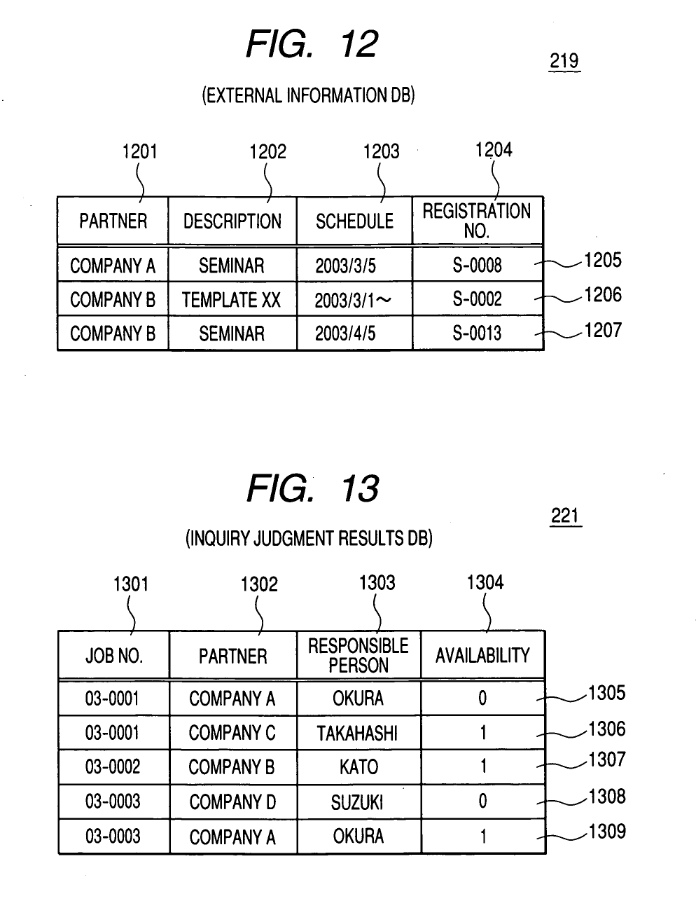

FIG. 12 is a layout diagram of a table to be managed by an external information DB 219. The table contains items of a partner 1201, description 1202, a schedule 1203 and a registration No. 1204. Each of the items contains such line data as represented by reference numerals 1205, 1206 and 1207, for example.

FIG. 13 is a layout diagram of a table to be managed by an inquiry judgment results DB 221. The table contains items such as a job No. 1301, a partner 1302, responsible person 1303 and availability flag 1304. Each of the items contains such data as lines from 1305 to 1309, for example. It shall be understood that a single job shall continue until the availability becomes “1.” Note that the judgment result “1” shall imply “Yes” and “0” imply “No”.

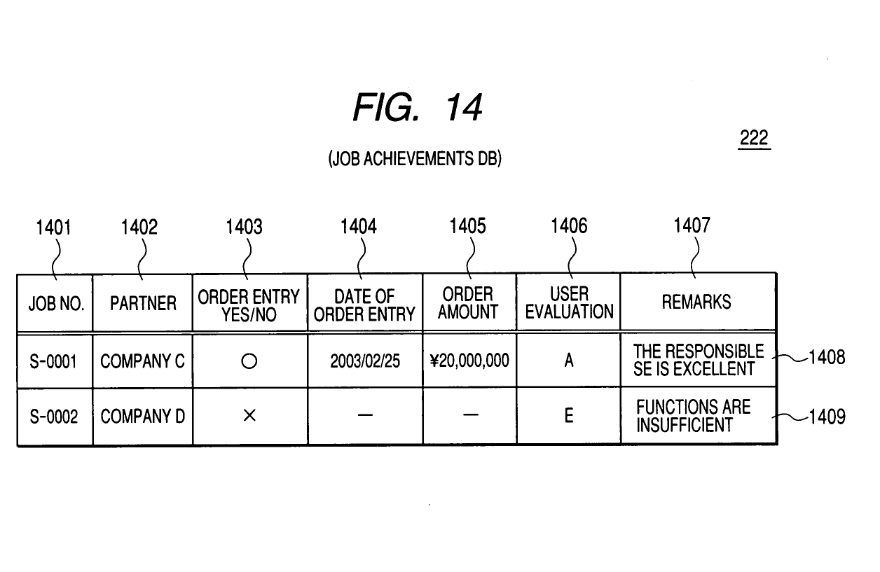

FIG. 14 is a layout diagram of a table to be managed by a job achievements DB 222. The table contains items such as a job No. 1401, a partner 1402 and order entry Yes/No 1403, in addition to a date of order entry 1404 and an order amount 1405 which come up when an order is received. The table further contains items of company evaluation values such as user evaluation 1406 and remarks 1407. For example, each of the items contains such line data as represented by reference numerals 1408 and 1409.

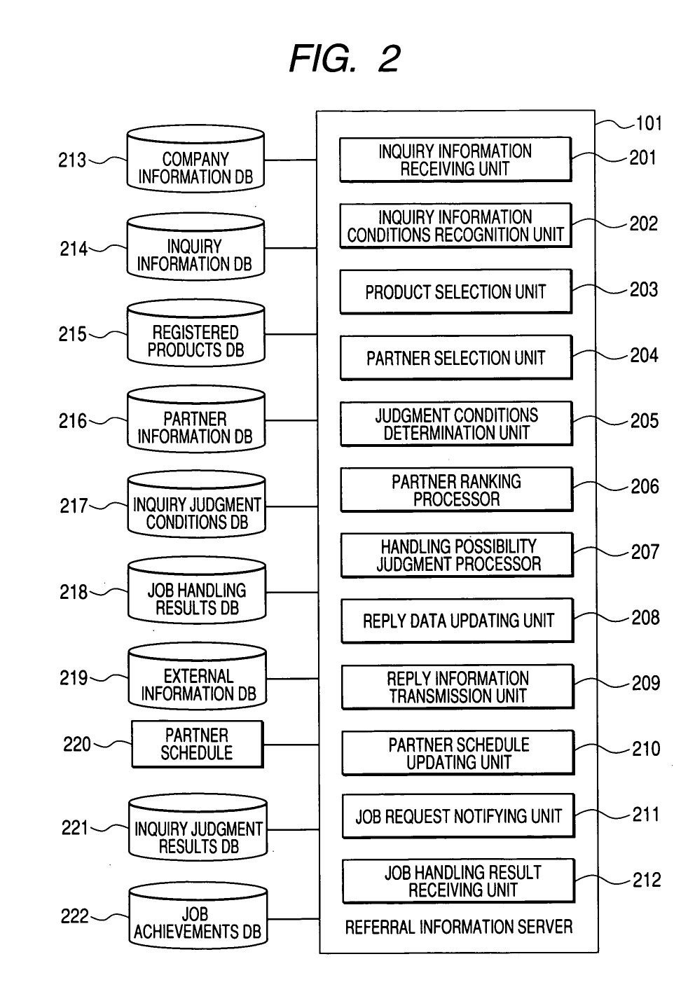

FIG. 2 is a configuration diagram of the referral information server 101. The referral information server 101 includes: an inquiry information receiving unit 201; an inquiry information conditions recognition unit 202; a product selection unit 203; a partner selection unit 204; a judgment conditions determination unit 205; a partner ranking processor 206; a handling possibility judgment processor 207; a reply data updating unit 208; a reply information transmission unit 209; a partner schedule updating unit 210; a job request notifying unit 211; and a job handling result receiving unit 212. The referral information server 101 is connected to such databases as: a company information DB 213; an inquiry information DB 214; a registered products DB 215; a partner information DB 216; an inquiry judgment conditions DB 217; a job handling results DB 218; an external information DB; a partner schedule 220; an inquiry judgment result DB 221; and a job achievements DB.

The inquiry information receiving unit 201 is adapted to receive inquiry information from the inquiry computers 103, and to store company information of the inquiry source in the company information DB 213 and inquiry information in the inquiry information DB 214.

The product selection unit 203 selects an applicable product in the registered products DB 215 based on the inquiry information.

The partner selection unit 204 selects a partner associated with the selected product, from the partner information DB 216.

The judgment conditions determination unit 205 determines judgment conditions from the inquiry judgment conditions DB 217 based on information of a type of inquiry 704 shown in FIG. 7.

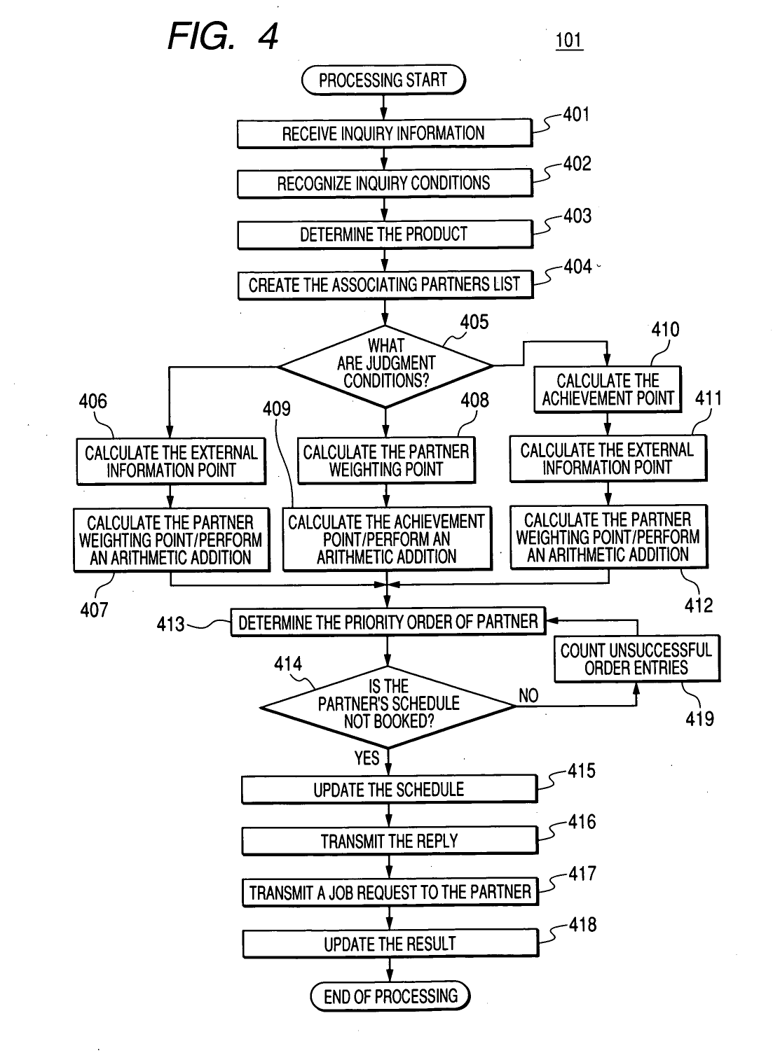

The partner ranking processor 206 fetches a point calculation method for executing ranking processing (which calculation method should be selected from Steps 406, 408 and 410 as shown in FIG. 4) based on the inquiry judgment conditions DB 217, calculates points by using predetermined calculation system, and ranks partners.

The handling possibility judgment processor 207 determines a partner company and a responsible person based on the partner schedule 220. For example, for a job No. “03-001” shown in FIG. 13, information that responsible person “Takahashi” is entered for a partner company C is determined.

The reply information updating unit 208 stores results from the handling possibility judgment processor 207 in the job handling results DB 218. For example, for the job No. “03-001”, information that a registered product “S-0001” is handled by the partner company C is stored.

The reply information transmission unit 209 returns reply information in inquiry information to the computer 103. For example, with an inquiry from a company ABC, such information that the registered product “S-001” for the job No. “03-001” is selected and the responsible person “Takahashi” at the partner company C is in charge of the product demonstration is returned.

In the partner schedule updating unit 210, the partner schedule 220 is updated to reserve a responsible person at the selected partner.

The job request notifying unit 211 notifies the selected partner computers 104 of a job request. For example, regarding an inquiry to the partner company C from the company ABC, for the job No. “03-001”, information on a request to the responsible person “Takahashi” for demonstration of the registered product “S-0001” and event information that updated the partner schedule 220 are notified.

The job handling result receiving unit 212 fetches handling result for the inquired job from the inquiry computer and stores the result in the job achievements DB 222.

The company information DB 213 is adapted to store detailed information on inquiry source company. FIG. 6 shows the table configuration.

The inquiry information DB 214 is adapted to store a requested date, a type of inquiry, a budget, and detailed information as information concerning an inquiry.

The registered products DB 215 is adapted to store detailed information on a registered product such as a product name and a price. FIG. 8 shows the table configuration.

The partner information DB 216 is adapted to store products on which respective partner companies are working on strenuously and weighting thereto. FIG. 9 shows the table configuration.

The inquiry judgment conditions DB 217 is adapted to store information to direct judgment procedures according to inquiry description. FIG. 10 shows the table configuration.

The job handling results DB 218 is adapted to store information on registered products allocated and selected partners for respective inquiry jobs. FIG. 11 shows the table configuration.

The external information DB is adapted to store information obtained by referring to a certain portion of a predetermined website of each partner company. An example of such information is that, concerning the website of the partner company A, a seminar on a registered product No. “S-0008” is held on Mar. 5, 2003. FIG. 12 shows the table configuration.

The partner schedule 220 is a file in which activity schedules of a responsible person of each partner company are entered in a specified format at a specified location in each partner computer 104.

The inquiry judgment results DB 221 is adapted to store history information obtained in partner selection process. An example of such history information is that, concerning the job No. “03-0001”, referral to the schedule of Okura of the company A according to the judgment criteria revealed that Okura is not available because the specified date is booked, and the next referral to the schedule of Takahashi of the company C, Takahashi is available. FIG. 13 shows the table configuration.

The job achievements DB 222 is adapted to store availability of order entry as a result of partner referral for an inquiry, and partner evaluation by the inquiry source company. For example, such information that, concerning an inquiry, the order is entered after the referral to products or partner companies, and remarks for the order entry that the responsible person is excellent and the evaluation is ranked A is stored in the table. FIG. 14 shows the table configuration.

Processing procedures in the referral information server 101 shown in FIG. 2 will be described later with reference to FIG. 4.

FIG. 3 is a configuration diagram of the partner analysis server 102. The partner analysis server 102 includes an achievement information aggregation processor 301, a partner information fetching unit 302, a comparison processor 303, and a result notifying unit 304. The partner analysis server 102 is connected to the job handling results DB 218, the inquiry judgment results DB 221, the job achievements DB 222 and the partner information DB 216.

The achievement information aggregation processor 301 fetches information from the job handling results DB 218, analyzes information associated with a job in an inquiry, fetches information from the inquiry judgment results DB 221, aggregates the partner selection history, fetches information from the job achievements DB 222, and finally aggregates job achievements after determination of a partner company.

The partner information fetching unit 302 fetches weighting information on products to which respective partner companies are making strong efforts, from the partner information DB 216.

The comparison processor 303 compares the result information output from the achievement information aggregation processor 301 with that from the partner information fetching unit 302. The comparison is calculated based on the results aggregated according to months, and the number of jobs actually handled and the success rates are calculated for each inquired job of products for which respective partner companies are making strong efforts. In addition, the number of unsuccessful order entries is calculated for each job. Next, availability evaluations on partner companies from the inquiry source company are retrieved. Thereafter, ranking of the inquired products is calculated according to monthly cumulative totals.

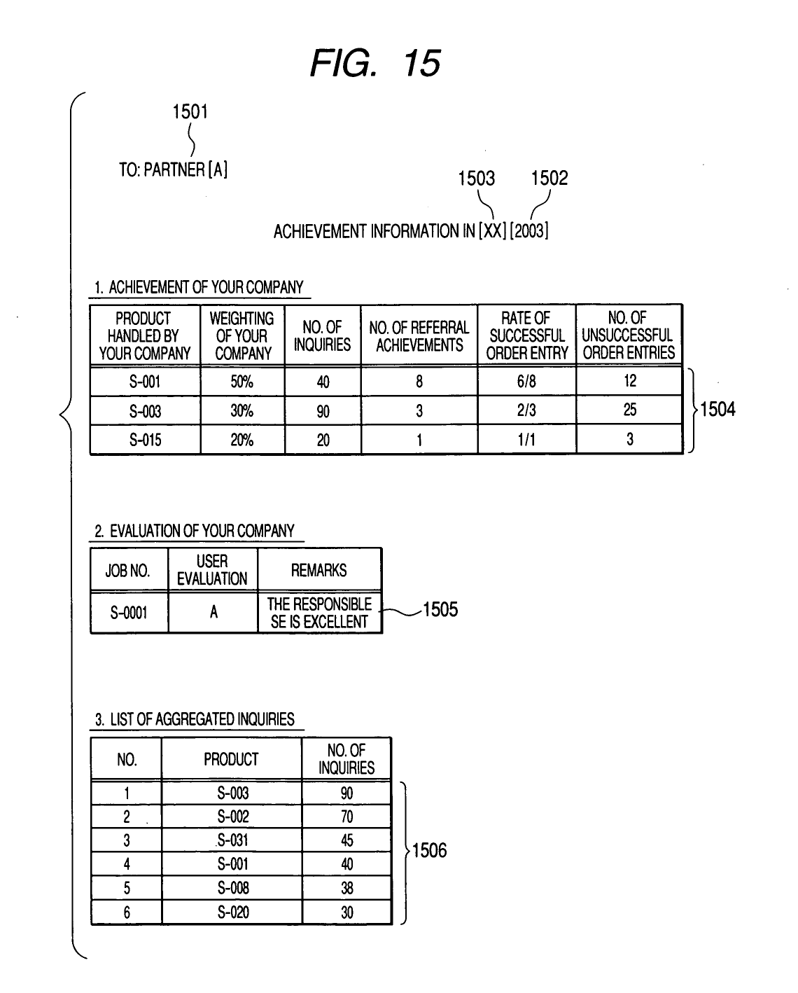

The result notifying unit 304 outputs the results obtained in the comparison processor 303 in the specified format as shown in FIG. 15, and the results are notified to respective partner computers 104. By using the information, for example, it is possible to prove that, as a result for a certain month, the partner company A gives a high weighting to the product S-001, though the number of inquiries for the product is 40 as represented by the market trend, while there are 70 inquiries for a product S-002 to which the partner company A does not give any weighting and emphasis. Eventually, data to rebuild the business action plan and review adequate products will be provided. In addition, the handling evaluation from the inquiry source company will eventually provide information for reviewing the company's policy.

Processing procedures of the partner analysis server 102 shown in FIG. 3 will be described later with reference to FIG. 5.

FIG. 4 shows a flow chart of processing procedures in the referral information server shown in FIG. 2. At the description end of each processing below, the reference numeral(s) of respective processors shown in FIG. 2 in which respective processing are executed will be shown in parenthesis.

First, company information and inquiry descriptions inquired are fetched from the company information DB 213 and the inquiry information DB 214, respectively (401) (201).

Conditions of descriptions thus fetched are recognized (402). In this process, information on the type of business, the annual turnover, etc. are fetched from the company information DB 213, and information on the budget, inquiry conditions, etc. are fetched from the inquiry information DB 214 (202).

Next, according to the information thus fetched, an applicable product is selected in the registered products DB 215 (403). In this process, product selection is carried out through retrieving based on predetermined conditions by using condition retrieval and concept retrieval functions (203).

Next, partner companies which handle the selected products are retrieved from the partner information DB 216 to select a partner company (404). In this process, if a plurality of partner companies are selected, the plurality of partner companies are listed up (204).

Then, information on the status of inquiry is fetched from the inquiry information DB 214, and the order of calculation priority is determined according to the inquiry judgment conditions DB 217 (405). The information on the status of inquiry in the inquiry information DB 214 contains a product referral request, a demonstration request and a development work request, and the status is judged based on the information on the status of inquiry. If the status is the product referral request, the process goes to Step 406. For the demonstration request, the process goes to Step 408, and for the development work request, the process goes to Step 410.

For the case of the product referral request, retrieval is first made from the external information DB 219 as to whether any event information is available on the product selected by the selected partner. For the retrieval result obtained, a predetermined point is calculated (406). Then, weighting information is fetched from the partner information DB 216, a predetermined point is calculated, and the point thus calculated is added to the point already calculated in Step 406 (407).

For the case of the demonstration request, weighting information on the selected product is first fetched from the partner information DB 216, and a predetermined point is calculated (408). Then, retrieval is made from the job handling results DB 218 as to whether there is any achievement in the past for the selected product, a predetermined point is calculated, and the point thus calculated is added to the point already calculated in Step 408 (409).

For the case of the development work request, retrieval is first made from the job handling result DB 218 as to whether there is any achievement in the past for the selected product, and a predetermined point is calculated (410). Then, retrieval is made from the external information DB 219 as to whether there is any event information on the product selected by the selected partner. For the retrieval result obtained, a predetermined point is calculated, and the point thus obtained is added to the point already calculated in Step 410 (411). Next, weighting information is fetched from the partner information DB 216, a predetermined point is calculated, and the point thus calculated is added to the point already calculated in Step 411 (412) (206).

For the above-stated three patterns, the calculation method determined based on the judgment conditions is applied, and orders of priority is given to the partner companies listed up in Step 404 according to the points calculated (413) (206).

For the partner company with the highest priority order, a judgment is made from the partner schedule 220 as to whether a responsible person is available on the requested date (414). When the responsible person is available, the process goes to Step 415. If the responsible person is not available, the process returns to Step 413, and, for the partner company with the second highest priority order, a judgment is made from the partner schedule 220 as to whether a responsible person is available on the request date.

If the person is not available, a process to count the number of unsuccessful order entries is applied to each job responded to an inquiry when returning to Step 413 (419). The result of the counting processing in Step 419 is utilized for aggregating the number of unsuccessful order entries according to partner companies (Step 501 in FIG. 5). With the above-described flow of processing, referral is made to schedule to make an inquiry to a certain partner company. Note that, however, the count implies the number of jobs that is transferred to other partner companies since the schedule is tight on the date requested by the inquiry source company. The judgment description is updated in the inquiry judgment results DB 221 (207).

Next, the partner schedule 220 of an available partner company is updated (415) (210). Information such as partner companies, responsible persons and selected products is replied to the inquiry computers 103 (416) (208).

Next, information in which partner schedule 220 is updated in Step 415 as well as information such as inquiry company information, inquiry description and selected products are transmitted to the partner companies 104 (211) to request the job (417) (209).

Upon replying an inquiry, information on resulting achievements is received from the inquiry computers 103, and the information is updated in the job achievements DB 222 (418) (212). This completes the processing.

FIG. 5 shows a flow chart of processing procedures in the partner analysis server 102 shown in FIG. 3. At the description end of each processing below, the reference numeral(s) of respective processors shown in FIG. 3 in which respective processing are executed will be shown in parenthesis.

First, information is fetched from the job handling results DB 218, the inquiry judgment results DB 221 and the job achievements DB 222. In addition, analysis of inquiry information, aggregation of selection results according to partner companies and aggregation of achievements after referral according to partner companies are executed as aggregation processing of achievement information (501) (301).

Next, weighting information on available products is fetched from the partner information DB 216 according to partner companies (502) (302).

Aggregation of achievements and weighting of products currently available are compared according to partner companies (503) (303), and the result is output according to the partner companies (504) (304). For the output information, random values are input and output in a standard format as shown in FIG. 15. This completes the processing.

FIG. 15 is an example of information screen to be transmitted to the partner companies 104 from the partner analysis server 102. A random value is input in entry boxes 1501, 1502 and 1503. According to conditions of the value, the number of unsuccessful order entries is output in addition to the number of referral achievements and successful order entry rates for inquiries to handling products shown in Table 1504. In addition, as shown in Table 1505, evaluation description from the inquiry source company is output according to jobs actually handled. Further, as shown in Table 1506, information on hot-selling product is output according to the whole inquiry information that is generated from the inquiry computers 103.

It is also possible that a program to execute the above-described referral method for handling information on order entry and sales according to the present invention is stored in a storage medium that is readable by a computer and is executed by reading the program in a memory.

### Second Embodiment

Hereinafter, a second embodiment will be described in detail with reference to the accompanying drawings.

With the second embodiment, a specialty business of a partner company is judged by using a prescribed formula based on sales achievements, etc. of the partner company. An object of the embodiment is to increase the number of inquiries to the inquiry computer 103 by acquiring company information on the judged type of business from the website of each company and sending product information to the companies.

In addition, it is possible to reduce loss in opportunities, since rapid quotation becomes feasible by systematically and automatically executing processes for a case where a quotation is requested to an inquiry computer.

With the first embodiment, the system is arranged to wait inquiries from companies passively. On the other hand, with the second embodiment, the object is to judge target companies dynamically by using a prescribed formula, and send product information, etc. to companies, thus increasing the number of inquiries to the inquiry computer 103.

Hereinafter, layouts of tables used in the second embodiment will be described. The tables are created in the referral information server 101. Exchange of information with a server other than the referral information server 101 is executed via a network.

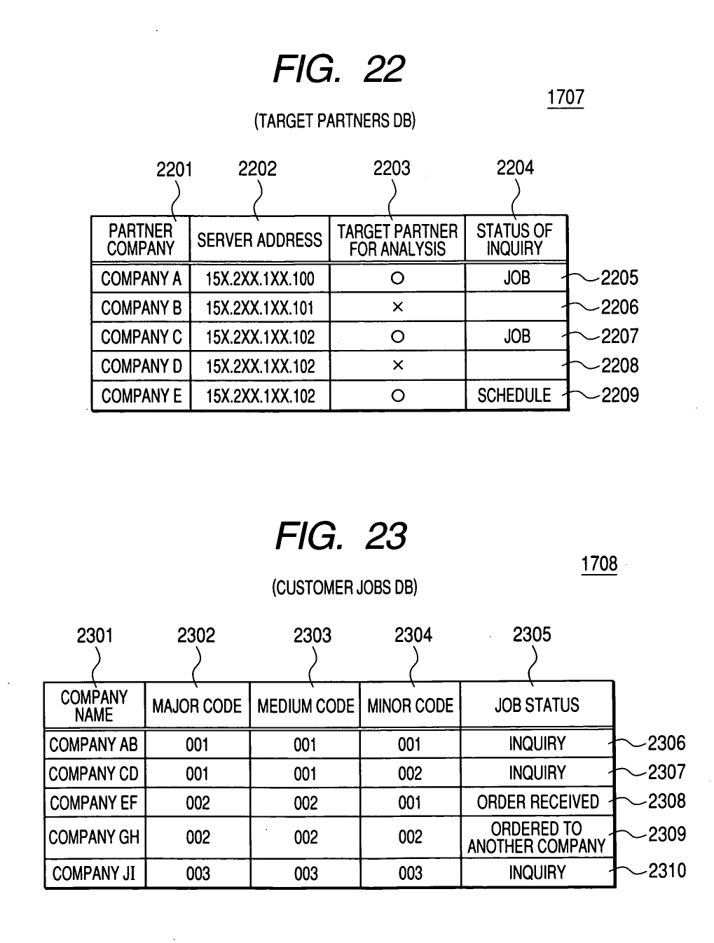

FIG. 22 is a layout diagram of a table to be managed by a target partners DB 1707. The table comprises a partner company (2201), a server address (2202), a target partner for analysis (2203) and status of inquiry (2204). The partner marked with “◯” in the Target Partner for Analysis should be the target partner or the partner to which a quotation is requested. What types of inquiry are made to servers dedicated to partner companies can be judged from the Status of Inquiry. For example, such line information as represented by reference numerals 2205, 2206, 2207, 2208 and 2209 are stored. The partner marked with “◯” in the Target Partner for Analysis and “Job” in the Status of Inquiry is designated to be an partner to be analyzed in the customer analysis server, and it is understood that the partner is currently in the status where the job inquiry is in process.

FIG. 23 is a layout diagram of a table to be managed by a customer jobs DB 1708. The table comprises a company name (2301), a major code (2302), a medium code (2303), a minor code (2304) and a job status (2305). For example, such line information as represented by reference numerals 2306, 2307, 2308, 2309 and 2310 are stored in the table.

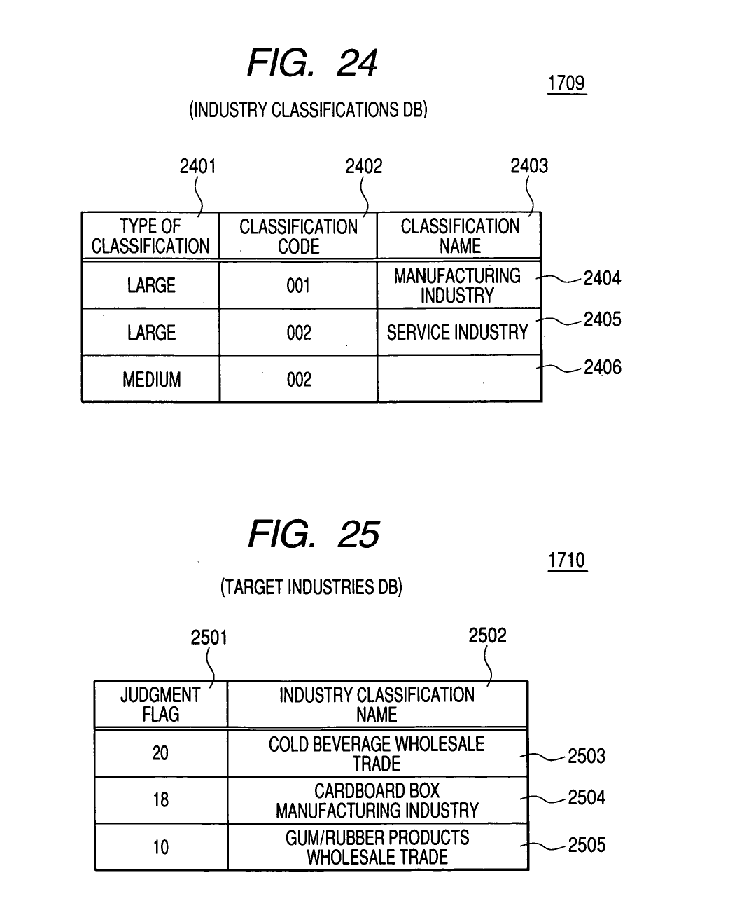

FIG. 24 is a layout diagram of a table to be managed by an industry classification DB 1709. The table comprises a type of classification (2401), a classification code (2402) and a classification name (2403). The type of classification is further classified into segments of large, medium and small. For example, such line information as represented by reference numerals 2404, 2405, 2406 is stored.

FIG. 25 is a layout diagram of a table to be managed by a target industries DB 1709. The table comprises a judgment flag (2501) and an industry classification name (2505). For example, such line information as represented by reference numerals 2503, 2504 and 2505 is stored in the table in an ascending order of judgment flags.

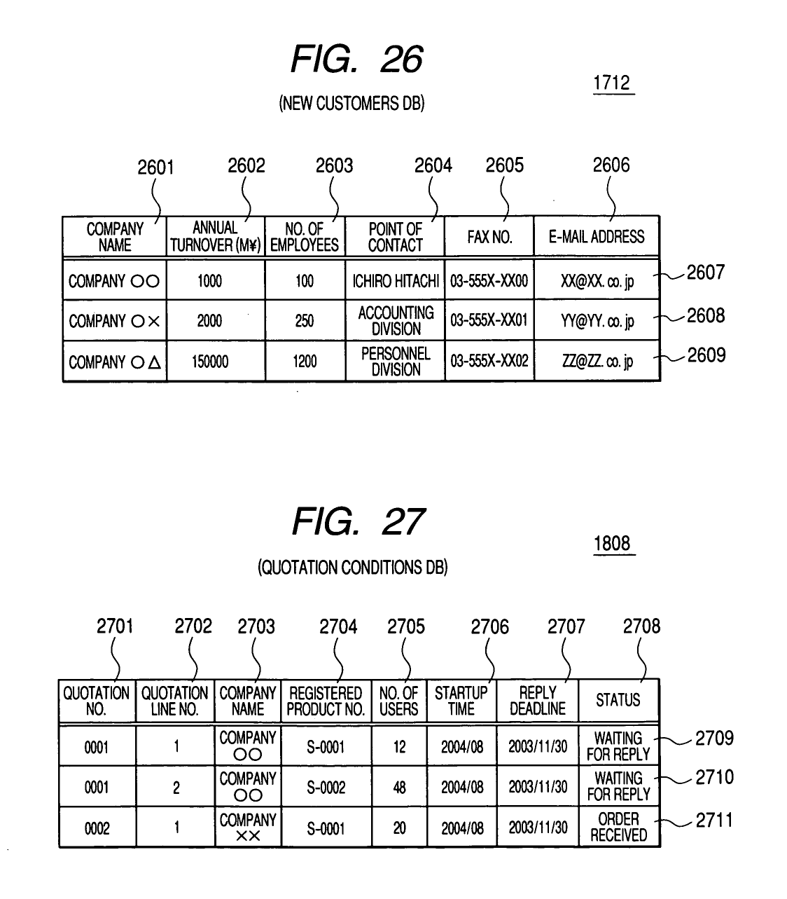

FIG. 26 is a layout diagram of a table to be managed by a new customers DB 1712. The table comprises a company name (2601), annual turnover (2602), No. of employees (2603), a point of contact (2604), a FAX No. (2605), and an e-mail address (2606). For example, such line information as represented by reference numerals 2607, 2608 and 2609 is stored in the table.

FIG. 27 is a layout diagram of a table to be managed by a quotation conditions DB 1808. The table comprises a quotation No. (2701), a quotation line No. (2702), a company name (2703), a registered product No. (2704), No. of users (2705), startup time (2706), reply deadline (2707) and status (2708). For the number of users the number of licenses for the registered product No. is stored. In addition, for the reply deadline, a quotation reply deadline is stored. The status comprises “order received”, “ordered to another company”, “waiting for reply” and “already replied to customer.” For example, such line information as represented by reference numerals 2709, 2710 and 2711 is stored in the table.

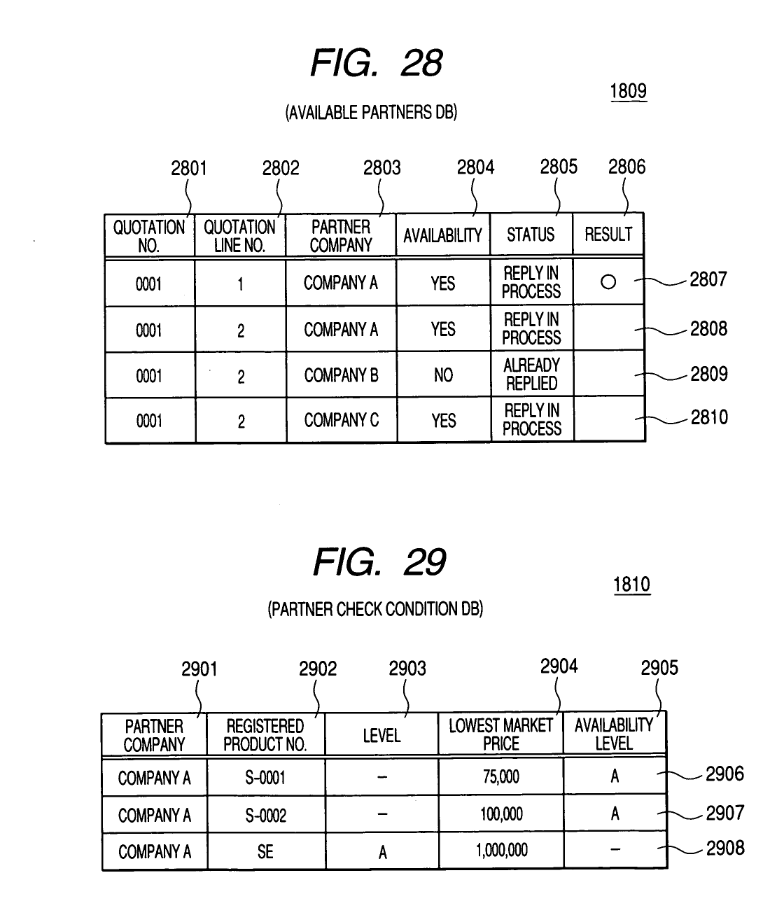

FIG. 28 is a layout diagram of a table to be managed by an available partners DB 1809. The table comprises a quotation No. (2801), a quotation line No. (2802), a partner company (2803), availability (2804), status (2805) and result (2806). The availability (2804) implies an item to store if job handling is possible or not possible as a result of an inquiry made to a server dedicated to a partner company. The status (2805) is used to store if a replay is in process or already made. “A reply in process” represents that the reply to a quotation is in process. “A reply already made” represents that a reply to a quotation has already been received. For the item “result” (2806), the partner which eventually accepted handling of the job is marked with “◯”. For example, such line information as represented by reference numerals 2807, 2808, 2809 and 2810 is stored in the table.

FIG. 29 is a layout diagram of a table to be managed by a partner check condition DB 1810. The table comprises a partner company (2901), a registered product No. (2902), a level (2903), a lowest market price (2904) and an availability level (2905). In the level (2903), a level of available SE is stored. The level shall be divided into A, B and C. In the availability level (2905), a level of a person who can handle the registered product No. is stored. The level shall be divided into A, B and C. For example, such line information as represented by reference numerals 2906, 2907 and 2908 is stored in the table.

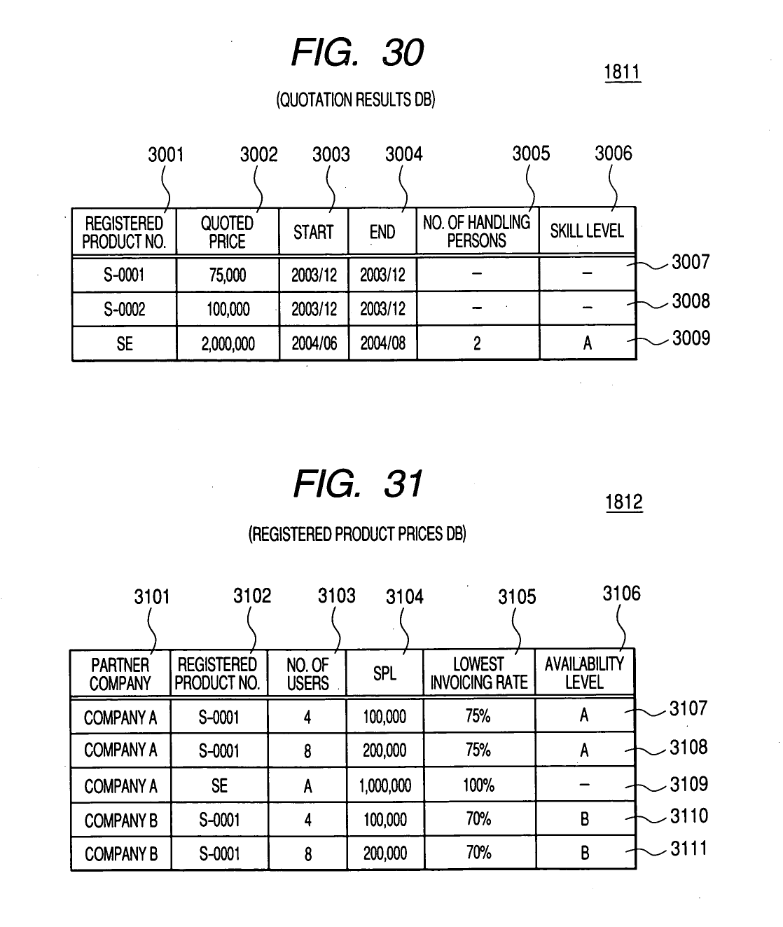

FIG. 30 is a layout diagram of a table to be managed by a quotation results DB 1811. The table comprises a registered product No. (3001), a quoted price (3002), start (3003), end (3004), No. of handling persons (3005) and a skill level (3006). In the registered product No., a product or a responsible SE is stored. In the start (3003), a year and a date on which the job handling can be initiated are stored. In the end (3004), a year and a month in which the job will be finished are stored. In the skill level (3006), the rank of responsible SE is stored. The rank shall be divided into A, B and C. For example, such line information as represented by reference numerals 3007, 3008 and 3009 is stored in the table.

FIG. 31 is a layout diagram of a table to be managed by a registered product prices DB 1812. The table comprises a partner company (3101), a registered product No. (3102), No. of users (3103), an SPL (3104), a lowest invoicing rate (3105) and an availability level (3106). The SPL should be a target product or a price of SE cost. In the lowest invoicing rate (3105), the lowest value of invoicing rate for the registered product No. of the partner company is stored. In the availability level (3106), an SE level which requires actions for a case where the partner company builds up the product of the registered product No. The SE level shall be divided into A, B and C. For example, such line information as represented by reference numerals 3107, 3108, 3109, 3110 and 3111 is stored in the table.

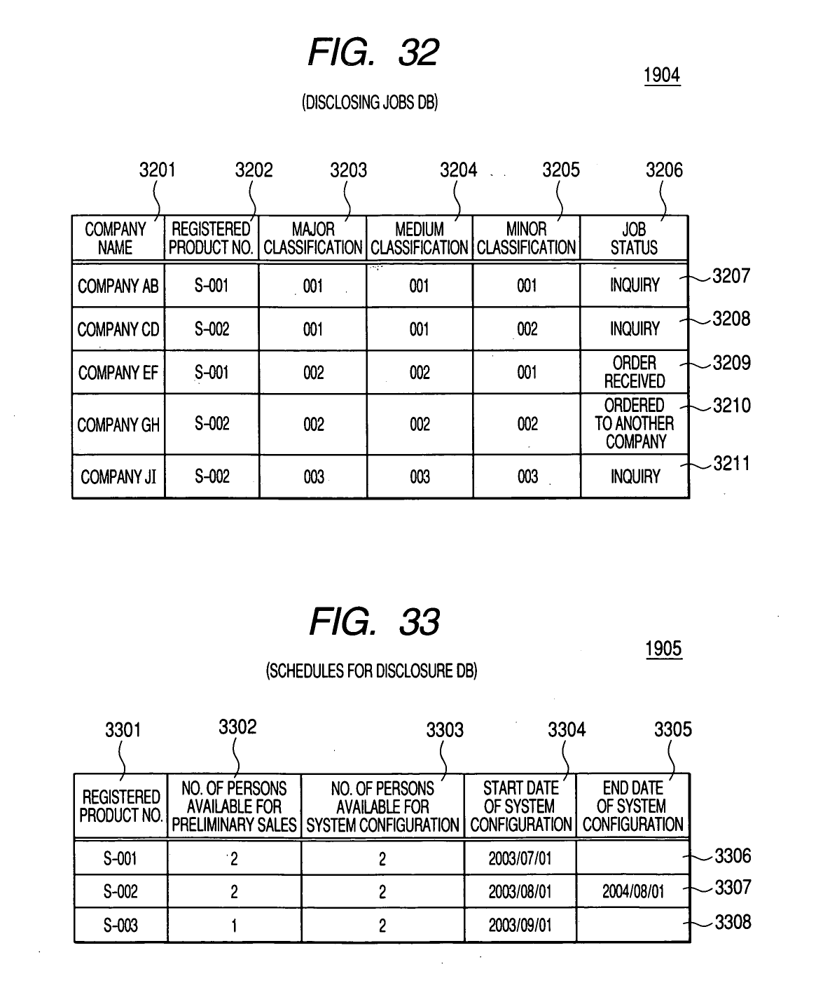

FIG. 32 is a layout diagram of a table to be managed by a disclosing jobs DB 1904. The table comprises a company name (3201), a registered product No. (3202), a major classification (3203), a medium classification (3204), a minor classification (3205) and job status (3206). For example, such line information as represented by reference numerals 3207, 3208, 3209, 3210 and 3211 is stored in the table.

FIG. 33 is a layout diagram of a table to be managed by a disclosing schedules DB 1905. The table comprises a registered product No. (3301), No. of persons available for preliminary sales (3302), No. of persons available for system configuration (3303), a start date of system configuration (3304) and an end date of system configuration (3305). In the No. of persons available for preliminary sales (3302), the number of persons available for preliminary sales is stored. In the No. of persons available for system configuration (3303), the number of persons available for system configuration is stored. In the start date of system configuration (3304), the year, the month and the day when the system configuration work can be initiated. In the end date of system configuration (3305), the year, the month and the day when the system configuration work must be finished is stored. For example, such line information as represented by reference numerals 3306, 3307 and 3308 is stored in the table.

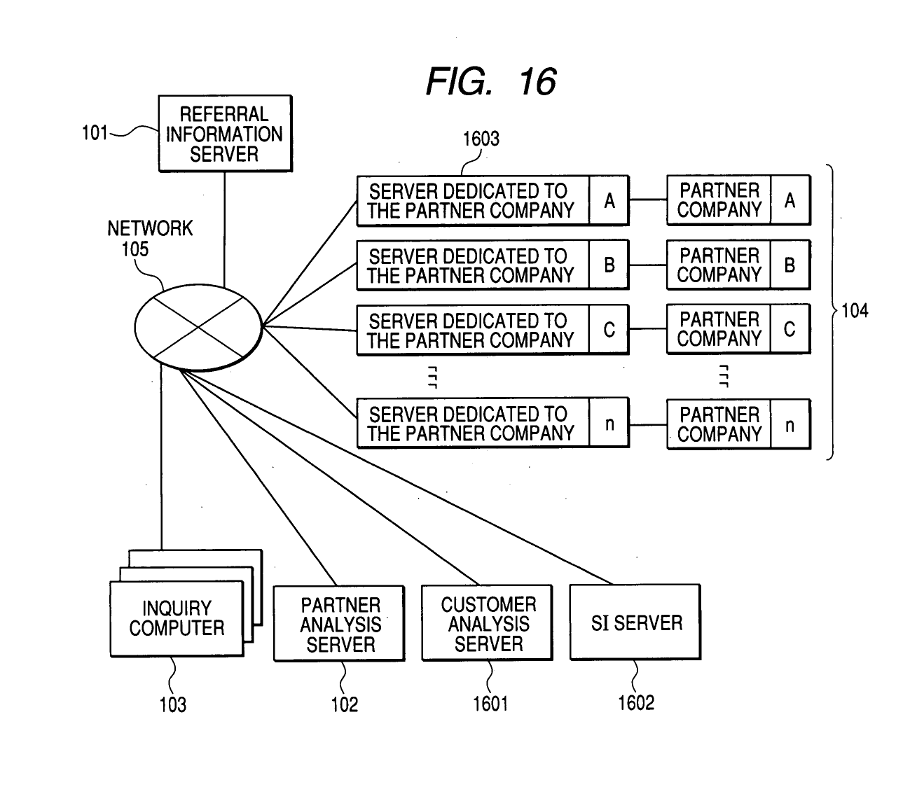

FIG. 16 is a system configuration diagram of the referral system for handling information on order entry and sales according to the second embodiment of the present invention. As shown in FIG. 16, the system is configured such that it includes a customer analysis server 1601, an SI server 1602 and servers 1603 dedicated to partner companies in addition to the components of the system configuration of FIG. 1 according to the first embodiment. The customer analysis server 1601 shown in FIG. 16 is adapted to acquire job information of respective partner companies from the servers 1603 dedicated to partner companies 1603.

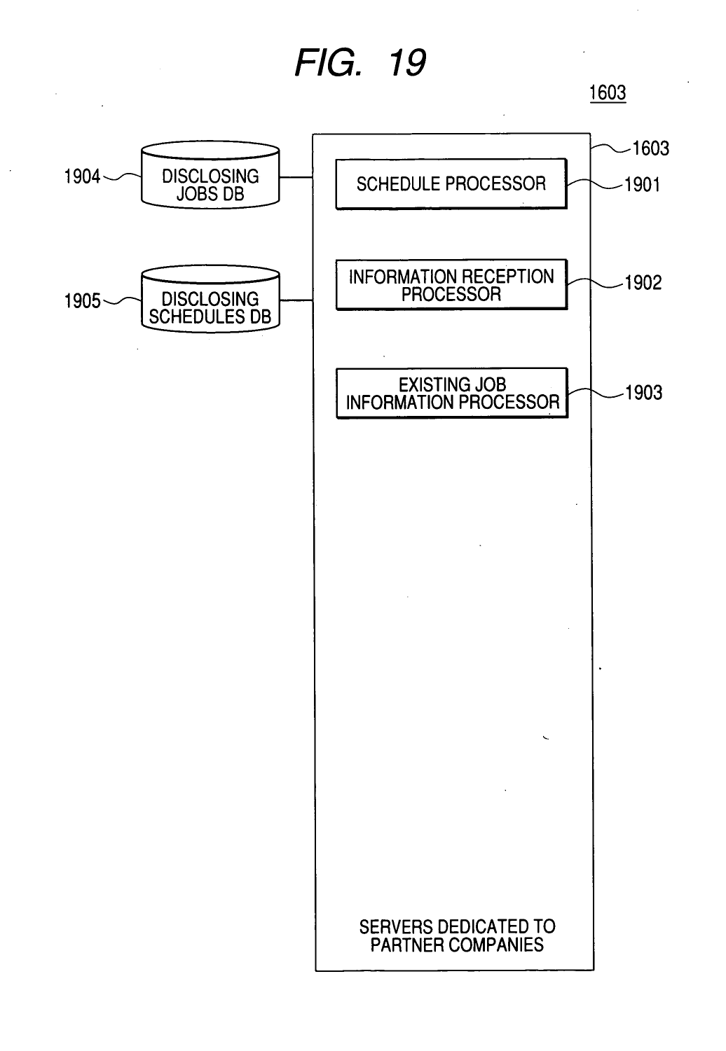

A method for acquiring the job information will be described later with reference to FIG. 19.

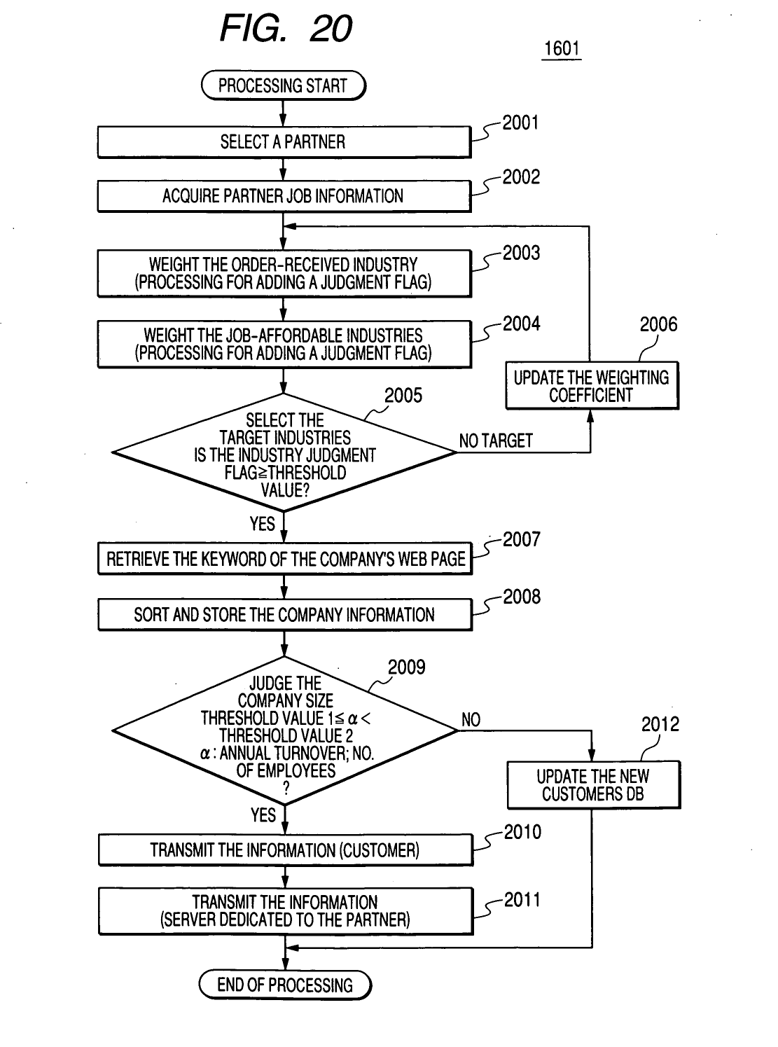

Here, the optimum types of business for a newly opening-up type of business is selected from the acquired job information, and information on companies belonging to the selected type of business is collected from the respective websites of companies. Further, companies that are worth being transmitted information are selected based on the company size, the annual turnover and the number of employees. A method for selecting the types of business and selecting companies that are worth being transmitted information will be described later with reference to FIG. 20.

The system has a mechanism in which product information of each partner company is transmitted to the selected companies to be opened up anew, and information on such companies to be opened up anew is transmitted to the partner companies.

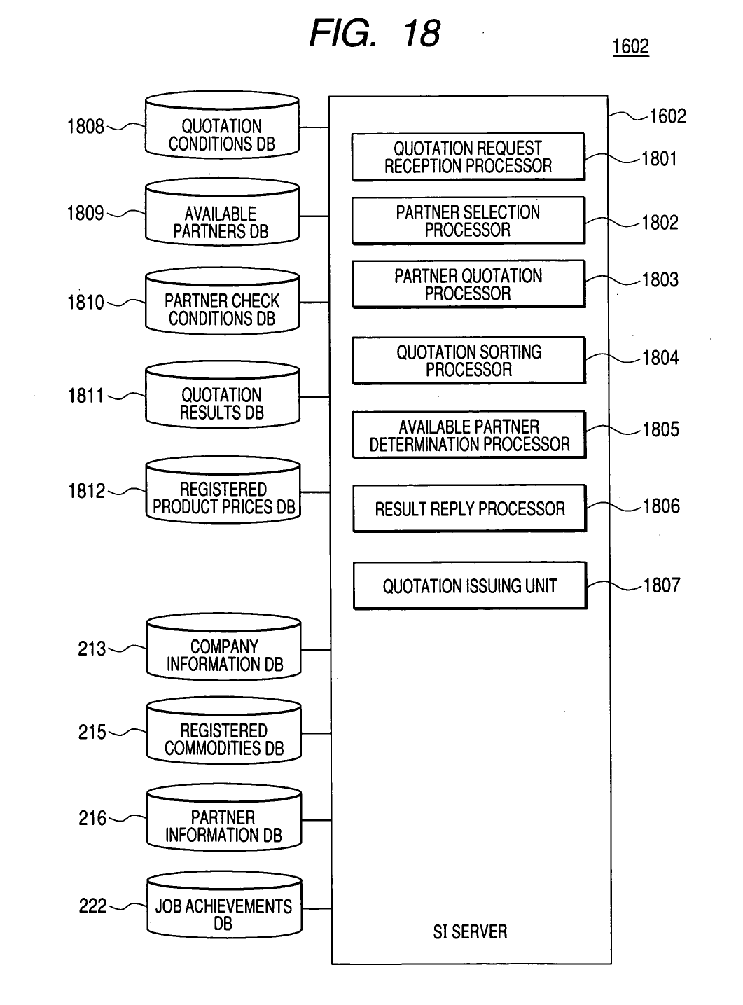

The configuration diagram of the SI server shown in FIG. 16 will be described later with reference to FIG. 18. In addition, the configuration diagram of the servers 1603 dedicated to partner companies will be described later with reference to FIG. 19.

It is possible to configure the customer analysis server 1601 and the SI server 1602 shown in FIG. 16 on the referral information server 101 as one and the same server.

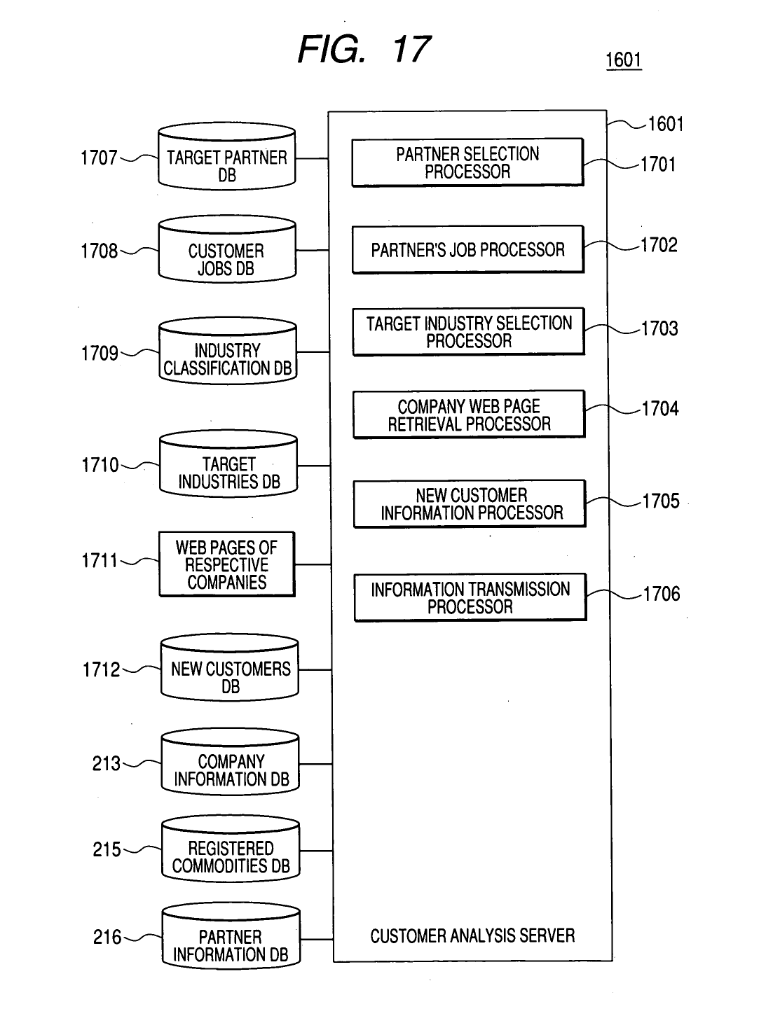

FIG. 17 is a configuration diagram of the customer analysis server 1601. With a partner selection processor 1701, a user expressly selects target partner companies from a screen, and the partner selection processor 1701 sends an inquiry to the servers dedicated to the partner companies 1603 of the partner companies to collect job information on the partner companies. The job information to be collected will be the job information of a disclosing jobs DB 1904 which is stored in the server dedicated to the partner company. FIG. 32 shows the table configuration of the disclosing jobs DB 1904.

The results thus collected are stored in the customer jobs DB 1708. FIG. 23 shows the table configuration. Information on the target partner companies is stored in the partner companies DB 1707. FIG. 22 shows the table configuration.

In a partner's job processor 1702, processing is made to couple a customer jobs DB 1708 with an industry classification DB 1709, weight the jobs of target partner companies by using a prescribed calculation formula, and add the weighting value to an industry judgment flag. FIG. 24 shows the table configuration of the industry classification DB 1709. For the weighting, it is possible to judge an industry which can exert strength of the target partner companies by giving a heavier weight to an order-received job.

A target industry selection processor judges an industry having a value exceeding the predetermined threshold value by using the result of the industry judgment flag calculated in the partner job processor 1702. The results of the industry judgment flag are stored in a target industries DB. FIG. 25 shows the table configuration of the target industries DB 1710.

A company Web page retrieval processor 1704 executes a keyword retrieval of company information Web pages of respective companies by using an industry classification name 2502 as a keyword. The retrieval results are stored in the new customers DB 1712. FIG. 26 shows the table configuration.

A new customer information processor 1705 selects companies which are worth being transmitted information by limiting the range of annual turnover and the number of employees. The company size to be targeted and selected will be companies of small and medium sizes. The targeted companies as a result of the judgment are stored in the new customers DB 1712.

An information transmission processor 1706 acquires FAX numbers and e-mail addresses from the company information of the new customers DB 1712 and transmits product information of the target partner companies. The product information and the partner company information are collected by coupling the company information DB 213, the registered products DB 215 and the partner information DB. In addition, information on new customers to which the product information is transmitted is transmitted to the target companies.

FIG. 18 is a configuration diagram of the SI server 1602.

A quotation request reception processor 1801 executes a process to receive a quotation request from the inquiry computer 103. The quotation request information thus received is stored in the quotation conditions DB 1808. FIG. 27 shows the table configuration.

A partner selection processor 1802 acquires partner companies which handle quotation target products and partner companies which have past achievements in handling jobs by coupling the registered products DB 215, the partner information DB 216 and the job achievements DB 222. The results thus acquired are stored in an available partners DB 1809. FIG. 28 shows the table configuration. In addition, the partner selection processor 1802 sends a schedule inquiry to the servers dedicated to partner companies 1603 and selects partner companies which can handle processes over the start of the job. Based on the result of the inquiry, information on partner companies whose schedule is not booked is stored in the available partners DB 1809.

A partner quotation processor 1803 transmits a quotation request to the servers dedicated to partner companies 1603. In addition, the partner quotation processor 1803 receives a quotation reply from the servers dedicated to partner companies 1603. The quotation information thus received is stored in a quotation results DB 1811. FIG. 30 shows the table configuration. Further, the partner quotation processor 1803 acquires partner's quotation conditions from the quotation results DB 1811 for the quotation reply from the partner company, and creates a partner check conditions DB 1810 according to the quotation conditions to judge adequacy of the quotation. FIG. 29 shows the table configuration of the partner check conditions DB 1810. The quotation adequacy is judged according to the money amount and the skill level of the available personnel. When the quotation is judged to be adequate, the process goes to the next step. If the quotation is judged to be inadequate, a request for another quotation is made to each of the servers dedicated to partner companies 1603.

A quotation sorting processor 1804 formulate the quotations from partner companies into a format as a quotation for the customer by adding a quotation to be added by the request source division. The result is then added to the quotation results DB and updated therein. An available partner determination processor 1805 selects available partner companies according to the quotation amount collected. The partner companies eventually selected are stored in the available partners DB 1809.

A result reply processor 1806 transmits final quotations in the unified form to the customer. In addition, a quotation issuing unit 1807 transmits the result (adopted or rejected) to the servers dedicated to partner companies 1603 which issued the quotation request.

FIG. 19 is a configuration diagram of the servers dedicated to partner companies 1603. A schedule processor 1901 receives a schedule inquiry from the SI server 1602, acquires available period of time and the number of persons from the disclosing schedules DB 1905, and reports the information to the SI server 1602. FIG. 33 shows the table configuration of the disclosing schedules DB 1905.

An information reception processor 1902 receives information transmission from the: customer analysis server 1601 and the SI server 1602. In addition, the information reception processor 1902 executes a process to deliver the information to the schedule processor 1901 or an existing job information processor 1903.

The existing job information processor 1903, upon receiving an inquiry from the customer analysis server 1601, executes processes to acquire job information from the disclosing jobs DB and transmit the information to the customer analysis server 1601. FIG. 32 shows the table configuration of the disclosing jobs DB 1904.

FIG. 20 is a flow chart of processing procedures in the customer analysis server 1601 shown in FIG. 17. At the description end of each processing below, the reference numeral(s) of respective processors shown in FIG. 17 in which each processing is executed will be shown in parenthesis.

First, a user expressly selects a partner to be analyzed on the screen (2001). The range of the partner to be analyzed can be limited (1701).

Server information of the partner companies selected in Step 2001 is extracted from the available partners DB 1707 and an inquiry for job information is made to each of the servers dedicated to partner companies 1603. In addition, the information thus acquired is stored in the customer jobs DB 1708 before the procedure proceeds to the nest step (2002) (1702).

Next, order-received jobs in the acquired information are weighted according to a predetermined calculation formula, and the calculation result is added to a judgment flag before the procedure proceeds to the next process (2003). Then, in the acquired information, jobs under handling and types of business of jobs for which orders are not entered are weighted according to a predetermined calculation formula, and the calculation result is added to a judgment flag before the procedure proceeds to the next process (2004). Thereafter, judgment is made on target industries by using the judgment flags obtained after the weighting is finished (2005). The target industries shall be those industries whose threshold values exceed a certain value. A threshold value implies a value that has already been predetermined internally. When the judgment resulted in one or more target industries, the procedure goes to Step 2007. If the number of target industries is zero (0), the weighting coefficient of the predetermined weighting calculation formula is automatically increased, and another target industry judgment is made by executing Steps 2003 and 2004.

In Step 2007, industry classification names that are judged to be target industries are acquired from the target industries DB 1710, and the websites of respective companies are retrieved by using the industry classification names as retrieval keys. Information to be retrieved shall be customer names, annual turnover, the number of employees, point of contacts, FAX numbers and e-mail addresses (2007). For companies whose information is acquired, the information is stored in the new customers DB 1712 in Step (2008) (1704).

Next, a judgment is made as to whether the company size to be processed is adequate or not in accordance with prescribed conditions. The point to be judged is whether the company is of a medium size in terms of the annual turnover and the number of employees (2009). When the judgment reveals the company is adequate, product information of the target partner companies is sent to the customer (2010) (1706). In addition, information on the customer to which the product information is sent is transmitted to the servers dedicated to partner companies. This completes the processing (2011) (1705). If the judgment reveals the company is inadequate, the new customers DB 1712 are updated before the processing is completed (2012).

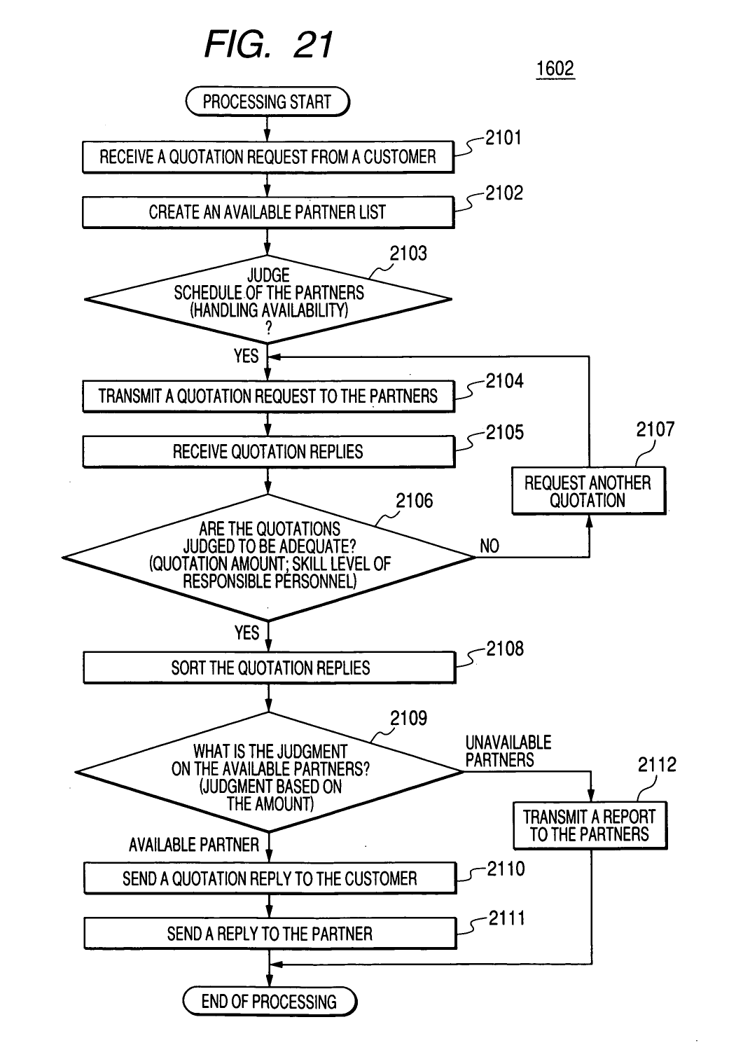

FIG. 21 is a flow chart of processing procedures in the SI server 1602 shown in FIG. 18. At the description end of each processing below, the reference numeral(s) of respective processors shown in FIG. 18 in which each processing is executed will be shown in parenthesis.

First, the SI server 1602 receives information on a quotation request from a customer from the inquiry computer 103 (2101) (1801).

Next, available partner companies are selected according to the information on the product for which a quotation request is received, and a partner list is created. For the method for selecting partner companies, they are acquired by coupling the quotation conditions DB 1808 and the registered products DB 215 or the job achievements DB 222. The result acquired is stored in the available partners DB 1809 (2102).

Next, an inquiry for schedule is made to each of the servers dedicated to partner companies 1603 from the available partners DB 1809 to acquire available partner companies. Based on the result thus acquired, the available partners DB 1809 is updated (2103) (1802).

Next, information on available partner companies is acquired from the available partners DB 1809, and a quotation request is made to the servers dedicated to partner companies 1603 before the procedure proceeding to the next step (2104).

In Step 2105, a quotation reply is received from the serves dedicated to partner companies 1603. Result of the quotation reply thus received is stored in the quotation results DB 1811 (1803).

In Step 2106, the partner check conditions DB 1810 is created by coupling the quotation conditions DB 1803, the available partners DB 1809 and the registered product prices DB 1812.

Comparison is made between the lowest invoicing price of the partner check conditions DB 1810 (2804) and the quotation amount of the quotation results DB 1811, and, if the quotation amount is lower than the lowest invoicing price, the quotation is judged not to be adequate. In addition, comparison is made between the availability level (2905) of the partner check conditions DB 1809 and the skill level (3006) of the row in which the registered product No. (3001) of the quotation results DB 1811 is set to “SE”. If the availability level (2905) is larger than the skill level, the quotation is judged not to be adequate (2106).

When the quotation is judged to be adequate, processing such as addition of quotation replies from other partner companies is executed (2108). If the quotation is judge not to be adequate, a request for another quotation is made (2107). After all quotations are sorted out, a combination that ensures the minimum quotation amount is determined before the procedure proceeds to the next step (2109) (1805).

In Step 2110, quotation information is sent to the customer before the procedure proceeds to the next step (1807).

Next, processing is executed to send the quotation information that has been submitted to the customer, to the partner companies whose availability is judged to be adequate (2111). For partner companies whose availability is judged not to be adequate, information indicating that the decision has been made to another partner is transmitted (2112) (1806).

It is also possible to store the above-described program to execute the referral system for handling information on order entry and sales according to the present invention in a storage medium which is readable with a computer, and read the program in a memory to execute it.

1. A referral system for handling information on order entry and sales comprising:
means adapted to receive an order via a network;
means for extracting providers which can handle said order received;
means for making inquiries to said providers for handling availability;
means for selecting a provider based on the inquiry result; and
means for making a reservation with said provider if said provider is available for handling;
wherein at lease part of information obtained through the above-stated means is provided to an orderer.

2. A referral system for handling information on order entry and sales comprising:
means adapted to receive an order via a network;
means for extracting providers which can handle said order received;
means for making inquiries to said providers for handling availability;
means for counting the number of inquiries;
means for counting the number of availabilities and unavailabilities as a result of making inquiries; and
means for comparing said number of counts according to providers.

3. A referral system for handling information on order entry and sales according to claim 2, further comprising:
means for delivering, to each provider via a network, the number of job referral achievements as a result of the inquiries and said comparison result for each provider;
means for delivering availability evaluations on a provider from an orderer to each provider; and
means for delivering current inquiry status to each provider.

4. A method of handling information on order entry and sales, comprising the steps of:
extracting providers which can handle an order that has been received via a network;
making respective inquiries to said providers for handling availability;
selecting a provider based on the inquiry result;
making a reservation at said provider if said provider is available for said reservation;
providing at least part of information obtained through the above-stated processing to an orderer; and
feeding back achievement information and/or various types of service information to said provider.

5. A referral system for handling information on order entry and sales comprising:
means for collecting job information of partner companies via a network;
means for selecting, based on the collected job information, type of business of companies to which information is transmitted;
means for collecting company information of companies which are adequate for said selected type of business;
means for making selection from the collected company information; and
means for transmitting product information for said selected company information.

6. A referral system for handling information on order entry and sales comprising:
means adapted to receive a quotation request via a network;
means for selecting available partner companies based on the information of said received quotation request;
means for Judging adequacy of quotation replies from said selected partner companies;
means for sorting out the quotation replies from said partner companies; and
means for selecting an available partner company based on said sorted-out quotation replies.

7. A referral system for handling information on order entry and sales comprising:
means for collecting respective schedules of partner companies via a network;
means for collecting job information of each of the partner companies;
means adapted to receive respective quotation replies of the partner companies; and
means for managing communications with each of the partner companies.

8. A method of handling information on order entry and sales, comprising the steps of:
collecting job information of partner companies via a network;
selecting types of business of companies to which information is transmitted based on said collected job information;
collecting company information of companies which are adequate for said selected types of business of companies;
selecting said collected company information; and
transmitting product information for said selected company information.

9. A method of handling information on order entry and sales, comprising the steps of:
receiving a quotation request via a network;
selecting available partner companies according to information of said received quotation request;
judging adequacy of quotation replies from said selected partner companies;
sorting out the quotation replies from said partner companies; and
selecting an available partner company based on said sorted-out quotation replies.

10. A method of handling information on order entry and sales, comprising the steps of:
collecting respective schedules of partner companies via a network;
collecting job information of each of the partner companies;
receiving respective quotation replies of the partner companies; and
communicating information to each of the partner companies based on said schedules, said job information and said quotation replies.

11. A computer-readable storage medium in which a program is stored to execute a referral system for handling information on order entry and sales, said referral system for handling information on order entry and sales comprising the steps of:
extracting providers which can handle an order that is received via a network;
making an inquiry to said providers for handling availability;
selecting a provider as a result of making an inquiry;
making a reservation at said provider if said provider is available for handling;
providing at least part of the above-stated information to an orderer; and
feeding back achievement information and/or various types of service information to said provider.
